(19) United States
(12) Patent Application Publication
(10) Pub. No.: US 2009/0006410 A1
(43) Pub. Date: Jan. 1, 2009

(54) SYSTEM AND METHOD FOR ON-LINE INTERACTIVE LECTURES

(76) Inventor: SEUNGYEOB CHOI, Los Angeles, CA (US)

Correspondence Address: PARK LAW FIRM, 3255 WILSHIRE BLVD, SUITE 1110, LOS ANGELES, CA, 90010, US

(21) Appl. No.: 11/771,897

(22) Filed: Jun. 29, 2007

(51) Int. Cl. G06F 7/00; G06Q 10/00

(52) U.S. Cl. 707/9; 705/5

(57) ABSTRACT

A system and method for implementing on-line interactive lectures are provided. The video and audio lectures are delivered to geographically dispersed students through the internet. The delivery may be performed in two different modes, which are live-broadcast (live lectures) and on-demand (archived lectures). Live-broadcast lectures are delivered to students in real-time while the lectures are recorded. The students may interact with the teacher and also other students using real-time communication methods. The real-time communication methods include text-based on-line chat, and video/audio conferencing systems. On-demand lectures are delivered to students on per-request basis. The students may interact with the teacher or other students using non-real-time communication methods. The non-real-time communication methods include message boards and emails. The system may collaborate with a learning management system (LMS) to control the level of access over the video/audio streams and communications.

### BACKGROUND OF THE INVENTION

The invention relates to a system and method for providing an on-line educational system. More particularly, the invention related to a method and system for on-line interactive lectures.

Online education has become increasingly popular with the advance of the internet. Online education provides useful options especially for those who pursue additional degrees or licenses while working as experienced personnel in their job field. Students receiving on-line education have the opportunity to complete their coursework without physically attending the classes.

While many on-line education methods and systems have been developed to provide an adequate education environment, none of them provided a convenient and effective learning environment that is comparable to a physical lecture.

### SUMMARY OF THE INVENTION

The present invention contrives to solve the disadvantages of the prior art.

An objective of the invention is to provide method and system for online education that effectively simulates functions of a physical lecture.

Another objective of the invention is to provide an effective on line access method and system for archived lectures.

In order to achieve the above-objectives, the present invention provides a system including a web server, a streaming server, an LMS (Learning Management System) server, a communication server, and multiple user computers connected to the servers through the internet. The web server constructs a collection of user interfaces that provides users with access to course contents including media streams (the level of access is determined by the LMS server). The streaming server serves as a broadcasting source and provides the media streams that can be decoded into video/audio frames and played on a user computer. The LMS server comprises a database server that stores various course contents and an authentication server that assigns a level of access control over the contents to each user. The communication server comprises a chatting server that provides text-based real-time communication medium, a conferencing server that provides a video/audio conferencing feature based on VoIP technology, and a message board server that provides a web-based messaging feature. The servers may be running either on different computers or on a single computer.

The lecture schedules are predetermined and stored in the LMS server. On the scheduled start of a lecture, the streaming server starts broadcasting the video and audio streams. The web server enables the links to live broadcast video/audio and real-time communications (e.g. chat room). The users can view the real-time lecture at the same time it is recorded, and they interact with the teacher and other students using a text-based chat client or video/audio conferencing system based on VoIP and Video-on-IP technology.

Once a lecture completes, the lecture video/audio files are stored in the streaming server and become available as an archived lecture on an on-demand basis. A link to the archived lecture is stored in the course contents DB of the LMS server. The web server provides the users with the links to lectures and non-real-time communications. The non-real-time communications may be performed using on-line message boards.

The methods for on-line interactive lectures comprise a log-in process that assigns a level of access to each connected user, a scheduling process for triggering predetermined tasks on the servers, and a process for constructing a user-interface based on the user permission and the course schedules.

The present invention is summarized again in view of the claims. The present invention provides an on-line education system that are connected to a plurality of user computers. The system includes a learning management system (LMS) server that stores course contents and assigns a level of access control over the contents to each user, a web server that comprises user interfaces that provides users with access to the course contents, a communication server that provides multiple connections among the users and a streaming server that serves as a broadcasting source and provides the media streams that can be decoded into video/audio frames and played on a user computer.

The communication server comprises a chatting server that provides text-based real time communication medium.

The communication server comprises a conferencing server that provides a video/audio conferencing feature. The conferencing server is based on VoIP technology.

The LMS server stores predetermined lecture schedule. The streaming server starts broadcasting the video and audio streams on the scheduled start of a lecture and the web server enables links to live broadcast video/audio and real-time communications.

The course contents comprise media streams. When a lecture completes, the streaming server stores the lecture video/audio files and a link to the archived lecture is stored in the course contents of the LMS server. The web server provides users with the links to lectures and non-real-time communications.

The communication server comprises a message board server that provides web-based messaging.

The non-real time communication is performed using on-line message boards.

The LMS server comprises a database server that stores the course contents and an authentication server that assigns a level of access control over the contents to each user.

The system further comprises a client module that is installed on the user's computer. The client module comprises a media player, a chatting unit and a video/audio conferencing unit.

The present invention also provides a method for on-line education that provides interactive lecture to a plurality of users via a communication network. The method includes steps of a log-in process that assigns a level of access to each connected user, a scheduling process for triggering predetermined tasks on the servers, a process for constructing a user-interface based on the user permission and the course schedules, a process of displaying live lecture and archived lecture based on the course contents.

The method further includes a process of providing a live lecture, in which a streaming server provides a live media broadcast, and a communication server provides a live chat session and/or a video/audio conference session.

The method further includes a process of providing an archived lecture, in which a streaming server delivers video/audio stream of a lecture when a user requests the lecture, and a user can communicate with another user via a message board.

With the above construction, the present invention has advantageous effects that the system and method effectively simulate the physical lecture environment while maintaining the flexibility and convenience of on-line education.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a screen diagram that shows a user interface constructed by a web server;

FIG. 2 is a screen diagram that shows an interactive live lecture;

FIG. 3 is a screen diagram that shows a real-time video/audio communication;

FIG. 4 is a screen diagram that shows contents related an archived lecture;

FIG. 5 is a screen diagram that shows a message board;

FIG. 6 is a block diagram that shows a system for on-line interactive lectures;

FIG. 7(a) is a block diagram that shows data flows in interactive live lecture;

FIG. 7(b) is a block diagram that shows data flows in interactive archived lecture;

FIG. 8 is a flow diagram for a method of providing on-line education;

FIG. 9 is a flow diagram for the process of displaying live and archive lectures;

FIG. 10 is a flow diagram for the process of providing a live lecture;

FIG. 11 is a flow diagram for the process of participating in a live lecture; and

FIG. 12 is a flow diagram for the process of interaction in an archived lecture.

### DETAILED DESCRIPTION OF THE INVENTION

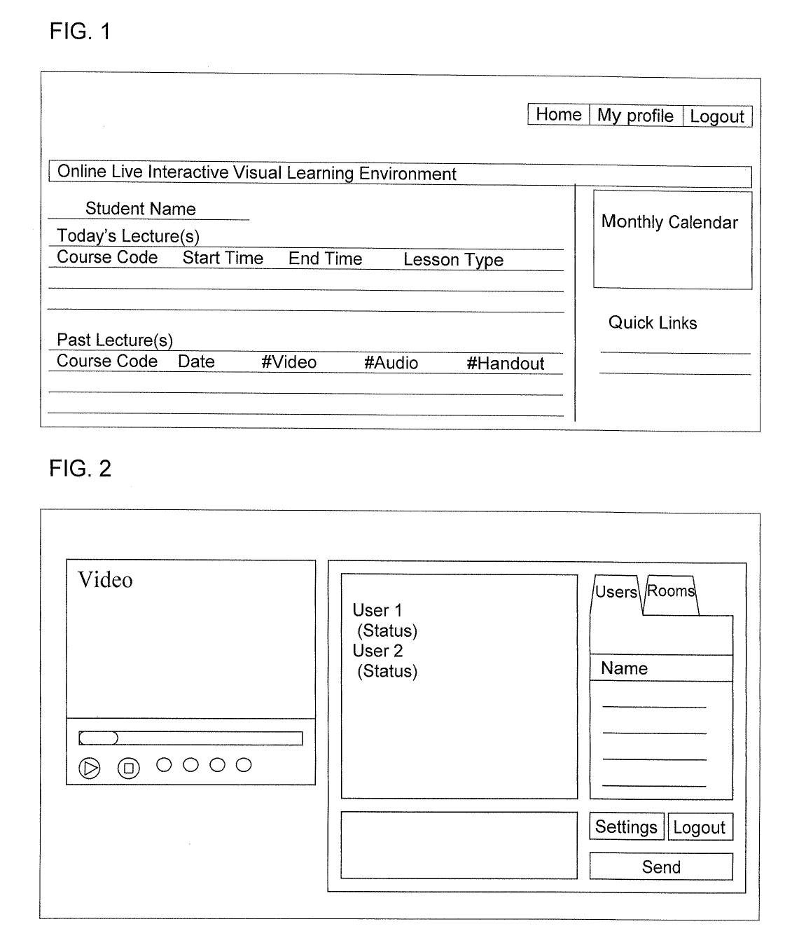

FIG. 1 is a screen diagram of the HTML-based user interface constructed by the web server based on the information from the LMS server. This HTML page is delivered and displayed on the user's screen upon log-in. The page provides the user with a list of available live lectures and archived lectures.

FIG. 2 is a screen diagram of an interactive live lecture. The video/audio lecture is broadcast to the student's computer. A chat client opens with the media player, and displays the text messages that are posted by other participants in real time. The user may also post her own message, and the message will then be sent to other participants' screen.

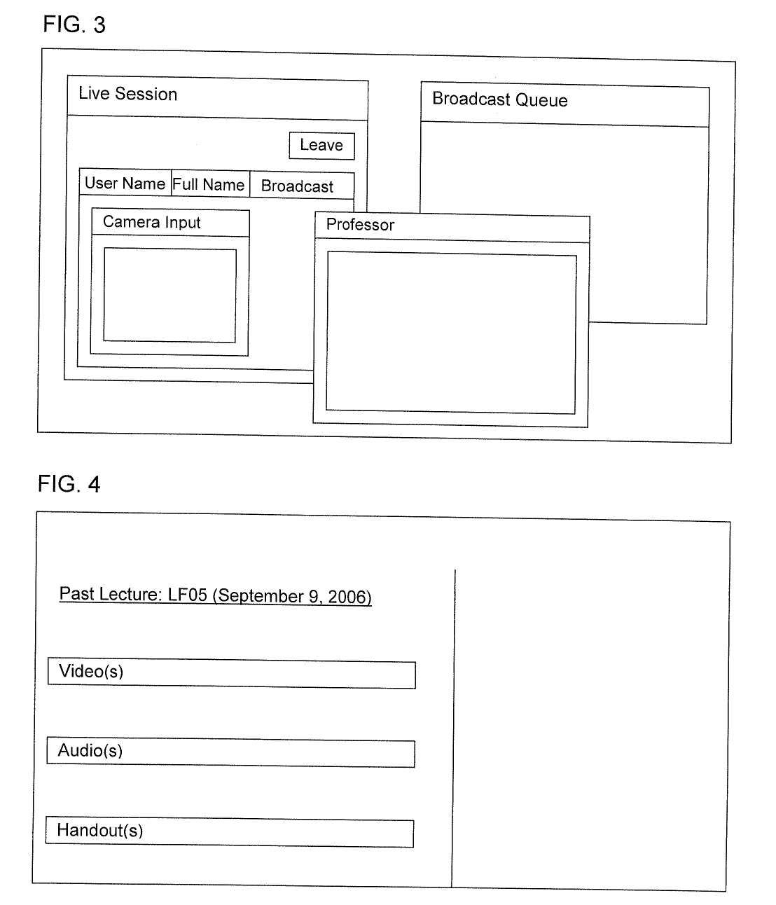

Instead of communicating with other participants using a text-based chat, a video/audio conferencing system may be used to communicate with other participants. FIG. 3 is a screen diagram of such video/audio communication system.

While a class is running, the lecture is broadcast as a “live” lecture and combined with real-time communication media. Once the class has finished, it is categorized as an “archived” lecture and provided on an on-demand bases in combination with non-real-time communication media. When a user logs into a course (run by the web server in collaboration with an LMS server), she is given a list of all available live and archived lectures as shown in FIG. 1. When she elects to access an archived lecture, the contents related to the lecture will be given. FIG. 4 is a screen diagram of the contents related to an archived lecture.

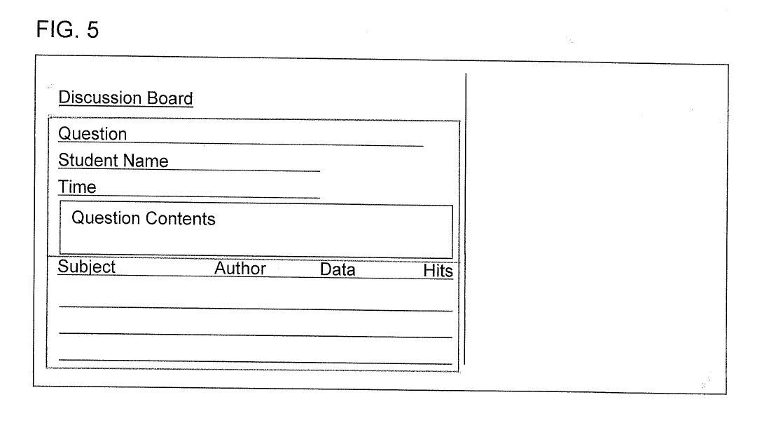

A message board (often called BBS) is attached to an archived lecture for non-real-time communications. Unlike a live lecture, the viewers of an archived lecture log in to the system at different time and view the different parts of the lecture. Thus, the interaction may not be performed in real-time. Messages (questions, answers, or comments) are posted by users and remain in the board for a longer period. Other users may reply to a previously posted message, and the reply is attached to the message and also available to be read by other users. FIG. 5 is a screen diagram of such message board.

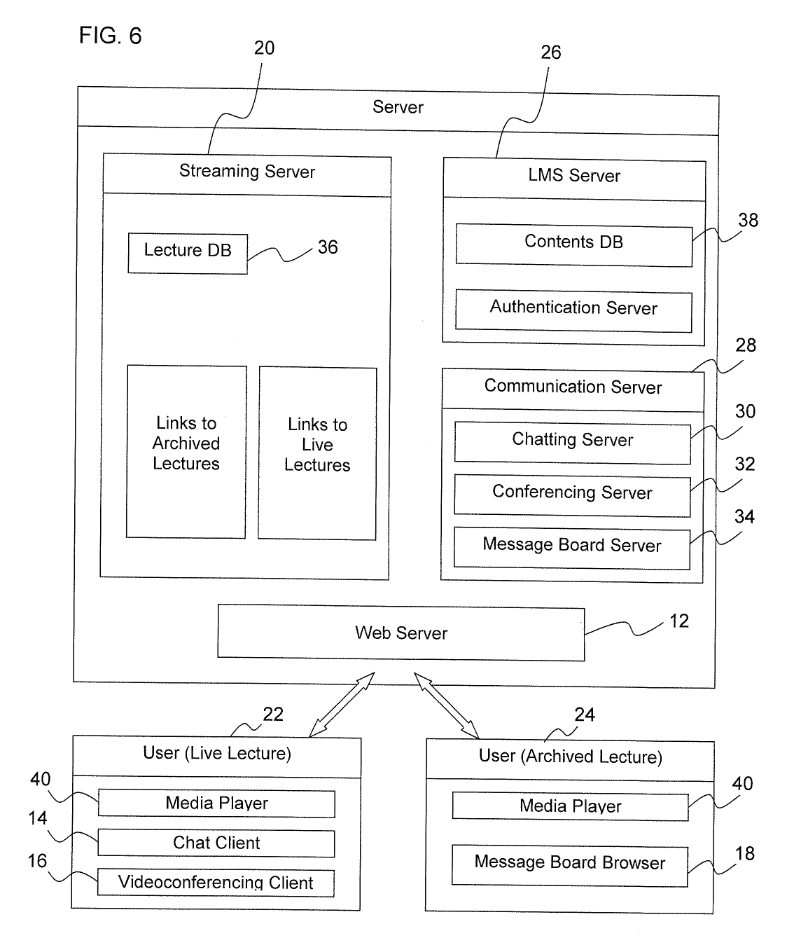

FIG. 6 is an architectural block diagram that describes the entire system structure. The users (either teacher or student) log in to the system through the user interface that is provided by the web server 12. Depending on the type of lecture the user accesses, the user's computer initiates either chatting/videoconference client 14, 16 (live lecture) or message board browser 18 (archived lecture).

The streaming server 20 sends the media streams to the user's computer 22, 24 through the internet. The examples of streaming servers are Microsoft's Media Services, Apple's QuickTime Streaming Server, Real Network's Real Media Server. The LMS server 26 stores the course contents and user accounts, and provides authentication and access control. The communication server 28 comprises a chatting server 30, a conferencing server 32, and a message board server 34, and enables each user to interactively communicate with one another.

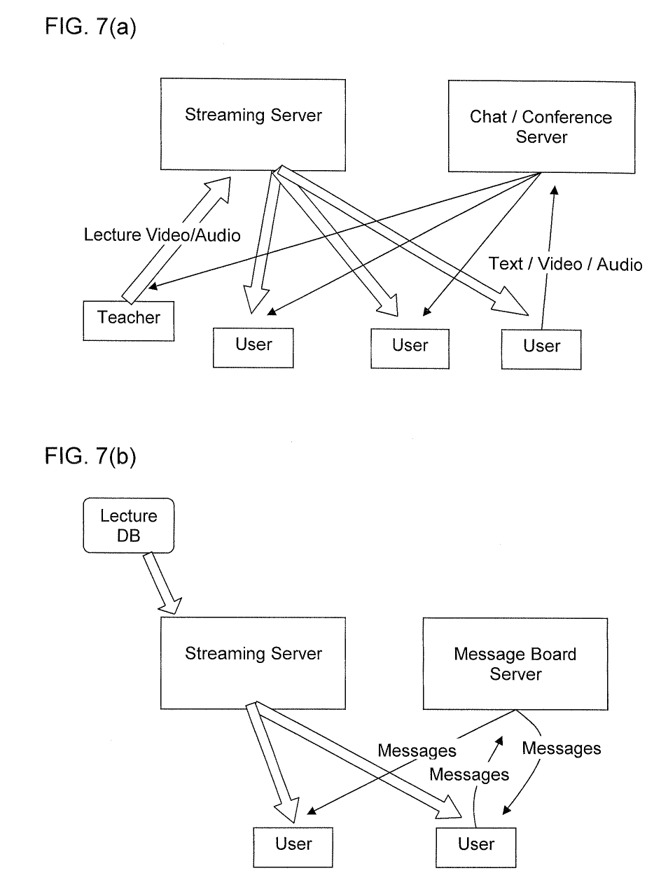

FIGS. 7(a) and 7(b) illustrate data flows in interactive live and archived lectures. In a live lecture, the lecture video/audio data are captured and encoded by the teacher's computer, sent to the streaming server 20, and broadcast to all users connected to the server. The users may interact with the teacher or other students using the chat-client 14 or the video/audio conferencing system 16. In that case, the text/video/audio data are sent to the chat/conference server 30, 32, and broadcast to other users. In an archived lecture, the archived video/audio data are requested by the user, retrieved from a lecture DB 36, and delivered to the user. The user may interact with the teacher or other user by posting a message on a message board. Other users may reply to a previously posted message, and in that case, the interaction is not performed in a real time but in a non-real-time way.

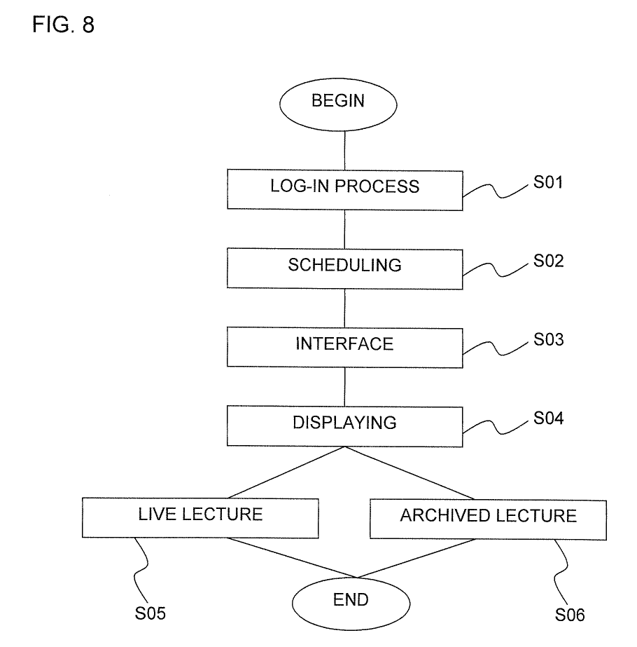

FIG. 8 is a flow diagram that illustrates a method for on-line education of the present invention. The method includes a log-in process S01 that assigns a level of access to each connected user, a scheduling process S02 for triggering predetermined tasks on the servers, an interface process S03 for constructing a user-interface based on the user permission and the course schedules, a displaying process S04 for displaying live lecture and archived lecture based on the course contents, a live lecture process S05 of providing a live lecture, in which a streaming server provides a live media broadcast, and a communication server provides a live chat session and/or a video/audio conference session, and a archived lecture process S06 for providing an archived lecture, in which a streaming server delivers video/audio stream of a lecture when a user requests the lecture, and a user can communicate with another user via a message board.

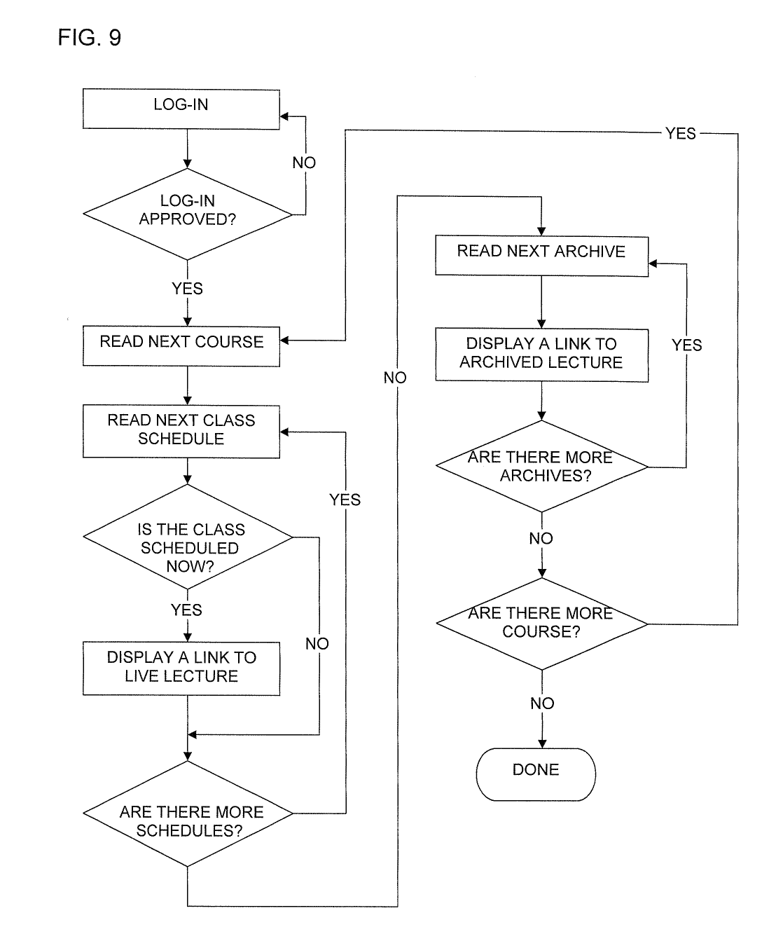

FIG. 9 is a flow chart that illustrates the process of displaying live and archived lectures based on the course contents (list of courses, list of class schedules for each course, list of archived lectures) stored in the contents database 38. The web server 12 takes in charge of this task in collaboration with the LMS server 26. Once a log-in is approved, the web server 12 reads all courses from the course contents database 38, and reads all class schedules and archived lectures for each course. If there is a class scheduled at the time, the live lecture is displayed. On the user's screen, all live and archived lectures that the user is supposed to access are displayed.

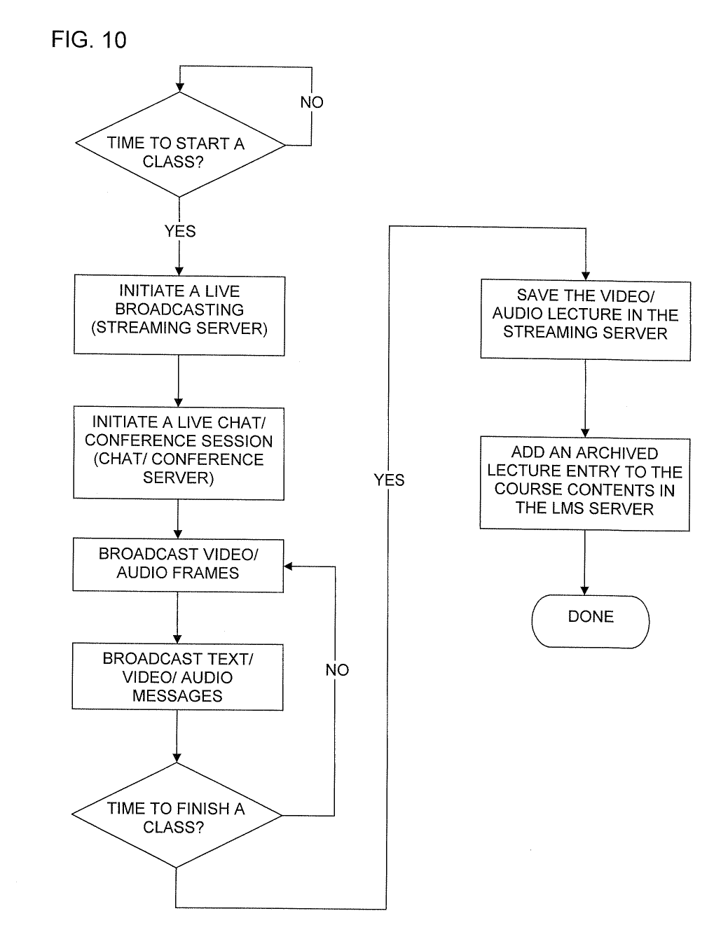

FIG. 10 is a flow chart that illustrates the process of providing a live lecture. When a class is scheduled to start, the streaming server 20 initiates a live media broadcast and the communication server 28 initiates a live chat/conference session. The video/audio frames recorded from the teacher's computer are broadcast to all users connected to the streaming server 20. The users can send their text/video/audio data to other users through the communication server 28. When the lecture finishes, the lecture video/audio files are stored in the streaming server 20 and its link is added to the course contents in the LMS server 26.

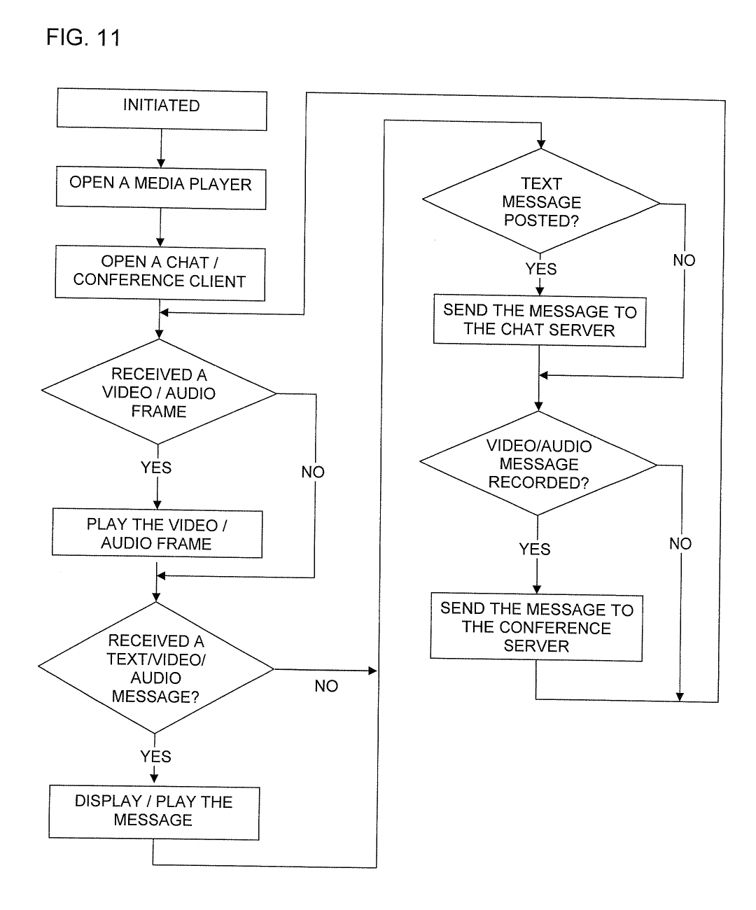

FIG. 11 is a flow chart illustrating the process to participate in a live lecture on the client side. Upon the start of a live lecture, a media player 40 and a chat/conference client 14, 16 are initiated (refer to FIG. 6). The media player 40 plays the live media stream. The chat client 14 sends the user's text input to the communication server 28. The conference client 16 captures the user's video/audio frames and send to the communication server.

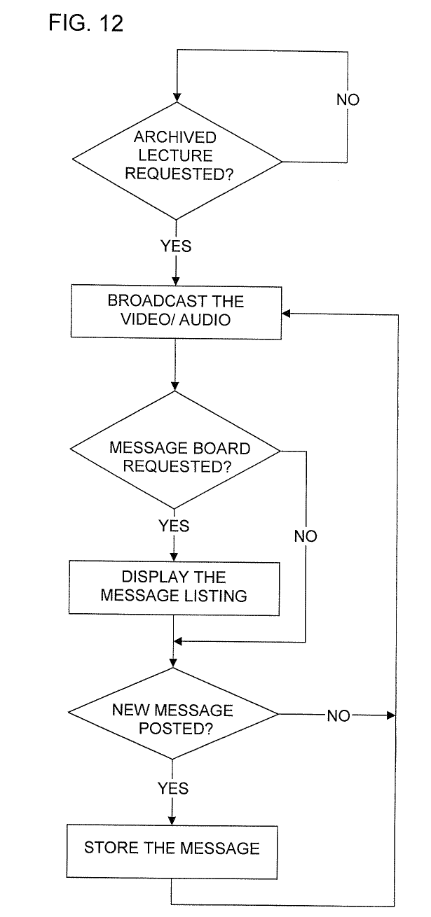

FIG. 12 is a flow chart that describes the interaction in an archived lecture. When a user requests an archived lecture, the streaming server 20 delivers the video/audio of the lecture. The user can access the list of messages attached to the lecture and read any messages from the list. She can also post her own message in the message board so that other users may also read and reply to.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. An on-line education system that are connected to a plurality of user computers, comprising:
a) a learning management system (LMS) server that stores course contents and assigns a level of access control over the contents to each user;
b) a web server that comprises user interfaces that provides users with access to the course contents;
c) a communication server that provides multiple connections among the users; and
d) a streaming server that serves as a broadcasting source and provides the media streams that can be decoded into video/audio frames and played on a user computer.

2. The system of claim 1, wherein the communication server comprises a chatting server that provides text-based real time communication medium.

3. The system of claim 2, wherein the communication server comprises a conferencing server that provides a video/audio conferencing feature.

4. The system of claim 3, wherein the conferencing server is based on VoIP technology.

5. The system of claim 3, wherein the LMS server stores predetermined lecture schedule, wherein the streaming server starts broadcasting the video and audio streams on the scheduled start of a lecture and the web server enables links to live broadcast video/audio and real-time communications.

6. The system of claim 3, wherein the course contents comprises media streams, wherein when a lecture completes, the streaming server stores the lecture video/audio files and a link to the archived lecture is stored in the course contents of the LMS server, wherein the web server provides users with the links to lectures and non-real-time communications.

7. The system of claim 3, wherein the communication server comprises a message board server that provides web-based messaging.

8. The system of claim 7, wherein the non-real time communication is performed using on-line message boards.

9. The system of claim 1, wherein the LMS server comprises a database server that stores the course contents and an authentication server that assigns a level of access control over the contents to each user.

10. The system of claim 1, wherein the communication server comprises a conferencing server that provides a video/audio conferencing feature.

11. The system of claim 1, further comprising a client module that is installed on the user's computer, wherein the client module comprises a media player, a chatting unit and a video/audio conferencing unit.

12. A method for on-line education that provides interactive lecture to a plurality of users via a communication network, comprising steps of:
a) a log-in process that assigns a level of access to each connected user;
b) a scheduling process for triggering predetermined tasks on the servers; and
c) a process for constructing a user-interface based on the user permission and the course schedules.

13. The method of claim 12, further comprising a process of displaying live lecture and archived lecture based on the course contents.

14. The method of claim 13, further comprising a process of providing a live lecture, in which a streaming server provides a live media broadcast, and a communication server provides a live chat session and/or a video/audio conference session.

15. The method of claim 13, further comprising a process of providing an archived lecture, in which a streaming server delivers video/audio stream of a lecture when a user requests the lecture, and a user can communicate with another user via a message board.
